(19) United States
(12) Patent Application Publication
(10) Pub. No.: US 2008/0077892 A1
(43) Pub. Date: Mar. 27, 2008

(54) Circuit unit designing apparatus, circuit unit designing method, and circuit unit designing program

(75) Inventors: Manabu Yamazaki, Kawasaki (JP); Makoto Suwada, Kawasaki (JP); Megumi Nagata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/790,666

(22) Filed: Apr. 26, 2007

(30) Foreign Application Priority Data
Sep. 27, 2006 (JP) 2006-263125

(51) Int. Cl. G06F 17/50

(52) U.S. Cl. 716/4

(57) ABSTRACT

A circuit unit designing apparatus configured to design a circuit unit in which, on a substrate, a plurality of circuit components are disposed, includes a circuit designing part carrying out circuit design; an initial characteristic calculating part calculating characteristics of the circuit unit from characteristics of the substrate and the respective circuit components, before the circuit design; an after design characteristic calculating part calculating characteristics of the circuit unit based on the circuit design result; a characteristic comparing part comparing the characteristics of the circuit unit obtained by the initial characteristic calculating part and the after design characteristic calculating part from one another; and an advice generating part generating an advice for a designer for a necessary design change based on the comparison result.

### BACKGROUND OF THE INVENTION

1. Field of the Invention

The present invention relates to a circuit unit designing apparatus, a circuit unit designing method and a circuit unit designing program, and, in particular, to a circuit unit designing apparatus a circuit unit designing method and a circuit unit designing program by which necessary design change can be efficiently carried out.

2. Description of the Related Art

In design of a circuit unit, in particular, a circuit unit using a serial interface for high-frequency band operations, it is necessary to check a loss (i.e., a signal transmission loss, also the same in the following description) or a jitter.

Recently, for an interface in a circuit unit, change from a parallel interface to a serial interface is proceeded with rapidly. For example, PCI or PCI-X used in a personal computer or a server is being changed into PCI Express; ATA used in a storage device such as HDD, CD-ROM or such is being changed into Serial ATA; and SCSI is being changed into Serial Attached SCSI.

Since the serial interface applies a high-frequency band, such a design way is demanded that, loss, jitter, noise and variation in signal transmission characteristics are appropriately managed, and thus, a stable transmission waveform is ensured.

For example, when a circuit unit is assumed to include a transmitter transmitting a signal waveform, a transmission path including a printed circuit substrate, a connector, a cable and so forth, and a receiver receiving the signal waveform, upon design of such a circuit unit, it is necessary to check performance, variation in devices, materials and so forth of the transmitter and receiver, as well as characteristics and noises of the respective elements of the transmission path.

As shown in FIG. 1, the circuit unit includes the printed circuit substrate, the cable, the connector and so forth, in addition to the transmitter and the receiver. In this case, the following items should be checked upon corresponding circuit design, for example:
Transmission/reception performance;
Variation in devices/materials/performance;
Power supply/crosstalk noises, reflection;
PCB (i.e., the printed circuit substrate, also the same in the following description) interconnections, vias, cables, connectors, transmission/reception device package losses.

In the design of the circuit unit, desk calculation such as loss budget calculation and jitter budget calculation of summing these losses and jitters, respectively and so forth, or, previous modeling, is carried out assuming respective elements, noises, variation and so forth, and then, a pre-analysis of a transmission waveform is carried out based thereon. Then, such a design rule is set for an artwork CAD (i.e., a CAD configured for printed circuit substrate artwork, also the same in the following description) for artwork, as to prevent the losses/jitters from exceeding those of initial estimation obtained from the desk calculation or the pre-analysis, and then, the artwork is carried out based on the thus-set design rule.

In the descriptions of the present application, ‘artwork’ means detailed design of a three-dimensional structure of a printed circuit substrate including detailed design such as disposition of respective circuit device components (LSI circuit devices, or such, also the same in the following description) on the printed circuit substrate of the circuit unit, disposition of interconnections between the circuit device components, i.e., final design applied for directly manufacturing a corresponding product.

Further, after the completion of the artwork, a simulation model is created with the use of a 3-D solver (an electromagnetic field analysis tool, for example, Poynting made by Fujitsu, Co., Ltd., or such), from a 3-D (i.e., three-dimensional, also the same in the following description) structure data, i.e., 3-D model data of the circuit unit. Also, a circuit simulator (a circuit simulation tool, for example, HSPICE made by Nihon Synopsis Co., Ltd, or such) is used to carry out a simulation, and thus, a transmission waveform appearing in the circuit unit is calculated (such processing will be referred to as a transmission simulation, hereinafter). Then, when it is determined from the simulation result that desired characteristics are not obtained from the artwork, the artwork should be carried out again to include necessary modification, or, the above-mentioned desk calculation is carried out again, and thus, a check of the packaging structure of the circuit unit should be carried out again.

In the description of the present application, ‘a check of a packaging structure’ means a check of general disposition of respective circuit device components included in the circuit unit and respective interconnections therebetween, i.e., a general check preparing for artwork.

However, considerably complicate works may be required for determining the artwork CAD design rule, and for setting the design rule for each interface. Further, since it is not possible to apply a detailed design rule to the artwork CAD, an artwork automatic check may not be carried out appropriately and thus, erroneous artwork may occur.

Further, such a situation may occur that, expected correction/improvement may not be achieved even when once the artwork is modified or even after such modification is repeated many times. Such a situation may occur in such a case where, when it is found out, after the artwork, that expected transmission characteristics cannot be achieved; a sufficient time to repeat the artwork cannot be obtained; an appropriate point to modify the artwork cannot necessarily be found out, or such.

Japanese Laid-Open Patent Application 2005-11892 discloses a related art.

### SUMMARY OF THE INVENTION

The present invention has been devised in consideration of the above-described situation, and an object of the present invention is to provide a circuit unit designing apparatus, a circuit unit designing method and a circuit unit designing program by which, even when a necessity occurs for changing design due to a factor unexpected from initial study for a packaging structure, the corresponding design change can be efficiently carried out, and it is possible to shorten a total time required for designing the circuit unit.

According to the present invention, based on the design contents obtained from circuit design, characteristics of the circuit unit are calculated again. Then the characteristics obtained before the circuit design and those thus-obtained after the circuit design are compared with one anointer, and, based on the comparison result, a necessary advice for a designer is generated for a design change.

For example, a computer may be used to automatically execute each step at appropriate timing. Thereby, the designer can recognize how a result of his or her own present design contents will influence final circuit characteristics, at any time during a circuit design procedure. As a result, the designer can appropriately carry out a necessary design change based on the recognition, and thus, it is possible to minimize a possible amount of returning to a previous design process occurring due to necessary design changes. Thus, it is possible to effectively reduce a total time required for the circuit unit design.

Thus, according to the present invention, it is possible that a designer can understand an influence of his or her own design contents on circuit unit characteristics, during a circuit unit design procedure, easily at any time. Accordingly, it is possible to carry out circuit unit design efficiently.

### BRIEF DESCRIPTION OF THE DRAWINGS

Other objects and further features of the present invention will become more apparent from the following detailed description when read in conjunction with the accompanying drawings:

FIG. 1 shows a block diagram for illustrating a problem in the prior art;

FIG. 2 illustrates a concept of an embodiment of the present invention;

FIG. 3 shows a block diagram for illustrating an operation flow of the embodiment of the present invention;

FIGS. 4 through 11 illustrate examples in which the embodiment of the present invention is applied; and

FIG. 12 shows a block diagram illustrating a configuration of a computer applicable as the embodiment of the present invention.

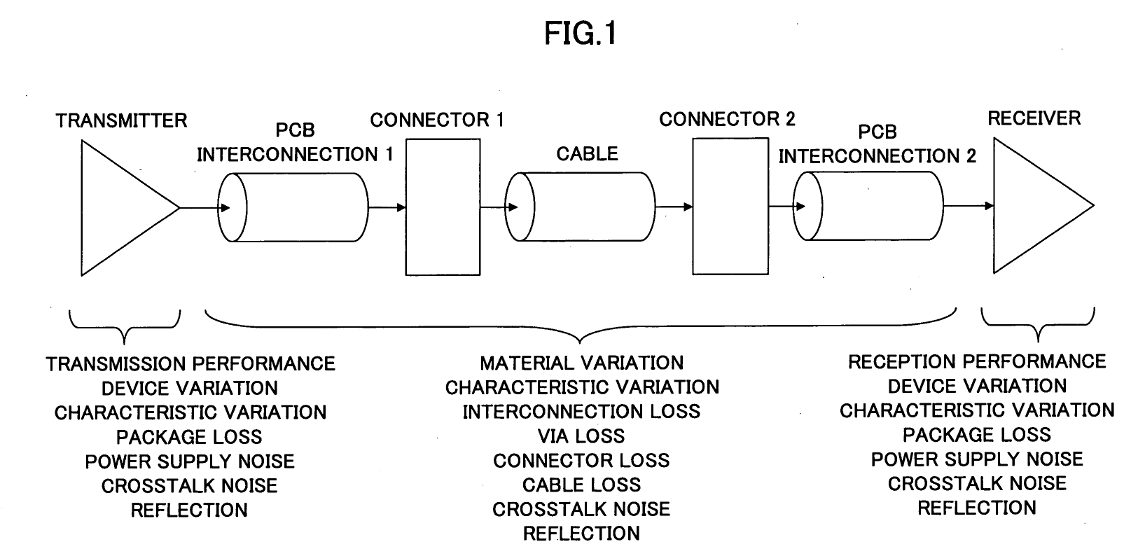

### DETAILED DESCRIPTION OF THE PREFERRED EMBODIMENT

With reference to figures, an embodiment of the present invention will now be described.

In a circuit unit designing system in the embodiment of the present invention, for a circuit unit in which a transmitter and a receiver are connected together by means of a transmission path, loss summation calculation (simply referred to as a ‘loss budget calculation’, hereinafter) is carried out for respective items, i.e., power supply noise, crosstalk noise, variation in device characteristics, variation in materials, for each element of vias, interconnections on a printed circuit substrate, cables, connectors and so forth, configuring the transmission path. Thus, desk calculation is carried out for the purpose of verifying whether or not signal transmission meeting predetermined requirements is available in the circuit unit.

Then, after the artwork of the printed circuit substrate, a simulation model is generated by means of a 3-D solver from the 3-D configuration of the artwork, and then, a final simulation, i.e., a transmission simulation is carried out for a transmission waveform.

Further, for the respective elements included in the circuit unit, for each of the above-mentioned desk calculation result (referred to as an ‘initial estimation’, hereinafter) and the final simulation result, a loss is calculated for each element and for each item, a difference therebetween is calculated, comparison is made between the initial estimation and the final simulation result, and respective elements for each of which the loss increases are obtained if any.

Further, in this case, it is preferable to provide an advice to the artwork designer as to how to modify the artwork for achieving loss adjustment required to overcome the issue of the difference between the initial estimation and the final simulation result, from a screen of an artwork CAD device.

Further, it is also preferable to provide an advice to the artwork designer as to how to modify the artwork for making a noise adjustment required to overcome the issue of the loss difference between the initial estimation and the final simulation result, from the screen of the artwork CAD device.

Further, it is also preferable to compare a result of the desk calculation (for the initial estimation) verifying whether or not signal transmission meeting the predetermined requirements is available, from carrying out jitter budget calculation for each item included in the circuit unit, with the final simulation result, so as to obtain elements and items for each of which the jitter increases from the initial estimation.

Further, it is also preferable to provide an advice to the artwork designer as to how to modify the artwork for making a jitter adjustment required for overcoming the issue of the difference between the initial estimation and the final simulation result, from the screen of the artwork CAD device.

Further, it is also preferable to carry out comparison between a result of design work carried out before the artwork (refereed to as a ‘pre-analysis’ hereinafter) for obtaining a signal transmission waveform by carrying out an operation analysis of the circuit unit by means of computer's arithmetic operations after modeling, for each item and for each element, and the result of the final simulation carried out after the artwork. Then, it is preferable to extract elements for each of which loss/jitter/noise increases in the final simulation result, from the pre-analysis result, so as to provide an advice to the artwork designer as to how to modify the artwork for a loss, jitter or noise adjustment required to overcome the issue of the difference between the pre-analyses result and the final simulation result, from the screen of the artwork CAD device.

Further, it is preferable to provide an advice to convert loss, jitter or noise of a certain element, into loss, jitter or noise of another element, as an alternative plan, as is necessary, when extracting artwork modification contents for a loss, jitter or noise adjustment, to overcome the issue of the difference between the initial estimation and the final simulation result, from the screen of the artwork CAD device.

Further, it is also preferable to provide an advice to deal with loss, jitter or noise of a certain element by modification of loss, jitter or noise of the same element, as is necessary, when extracting artwork modification contents for a loss, jitter or noise adjustment to overcome the issue of the difference between the initial estimation and the final simulation result, from the screen of the artwork CAD device.

Further, it is preferable to generate a simulation model by means of a 3-D solver from 3-D configuration data during or after artwork of a printed circuit substrate, to calculate, at any time, loss, jitter or noise of each element and of each item, to calculate differences from the initial estimation, and thus to separately compare from the initial estimation, and to extract elements and items, each of which loss, jitter or noise increases.

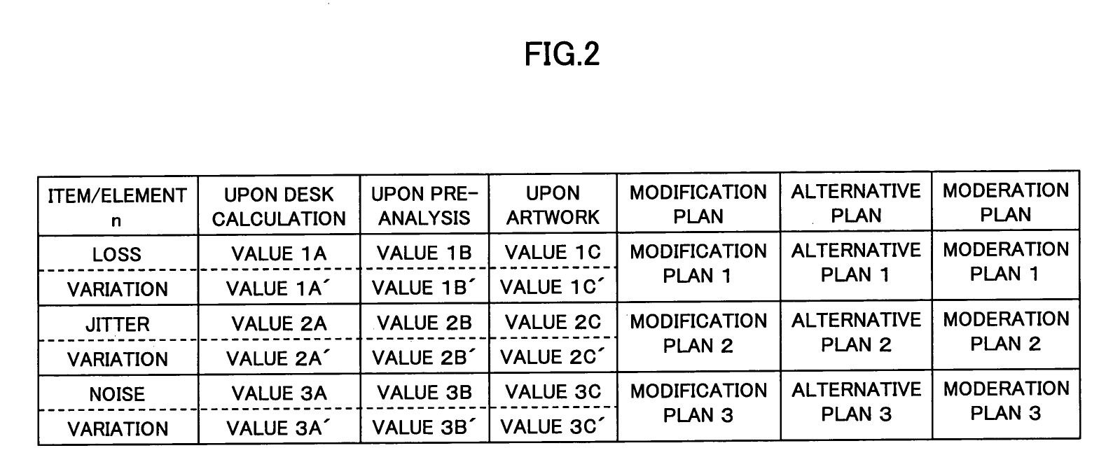

In the embodiment of the present invention, in order to provide these functions, respective information such as an initial estimation result (‘upon desk calculation’ in FIG. 2), a pre-analysis result (‘upon pre-analysis’) and a final simulation result after artwork (‘upon artwork’) are linked. FIG. 2 illustrates a general concept thereof.

As shown in FIG. 2, for the respective elements included in the circuit unit, i.e., the transmitter, the receiver, as well as the interconnections, the connectors and so forth provided on the printed circuit substrate configuring the transmission path therebetween, variation amounts of loss, jitter, noise, characteristics in each item of power supply noise, crosstalk noise, device characteristic variation, material variation and so forth, are calculated in each stage of the desk calculation, the pre-analysis and the artwork. Then, the thus-obtained information are linked together.

As a result, the artwork designer can at any time obtain a mutual comparison result for each item during the artwork. By obtaining the information, the artwork designer can at any time understand a possible occurrence of characteristic degradation caused by an unexpected factor, during the artwork, and can proceed with the artwork with carrying out, as is necessary, a design change in a detailed manner each time when the necessity arises. Accordingly, it is possible to minimize a possible loss in a design time period occurring due to returning to a previous design process, and thus, it is possible to effectively reduce a total design time period.

That is, according to the present embodiment, with the conventional function of the artwork CAD device, respective information of the desk calculation result, or the pre-analysis result, i.e., the initial estimation, is linked. Thus, it becomes possible to share, among the respective stages, budgets of the variation amounts of loss or jitter of each element for each item, which may advertently influence final operation performance of the circuit unit.

Specifically, on a display screen (referred to as a CAD screen hereinafter) of the artwork CAD device, information concerning transmission/reception characteristics and variation thereof are displayed for the respective circuit devices disposed on the printed circuit substrate, together. Further, the 3-D model of the present artwork contents is calculated from the information obtained from the artwork CAD device, a 3-D solver is applied to calculate the variation amounts of loss or jitter of each element for each item. Then, at any time, power supply noise or crosstalk noise occurring in the present artwork contents are calculated, and are compared with the budgets.

Further, based on the comparison results from the budgets, as is necessary, conversion is carried out for when replacing loss or jitter of an element or of an item, which acts as a factor of present characteristic degradation, into loss or jitter of another element or another item, and thus, an advice is submitted to the artwork designer as an alternative modification plan.

Thereby, it is possible to recognize a difference from the initial estimation during or after the artwork. Further appropriate modification contents are provided to the artwork designer so that the artwork designer can recognize the same to carry out the corresponding modification on the present artwork contents, thus, the circuit unit designing according to the initial estimation can be properly achieved.

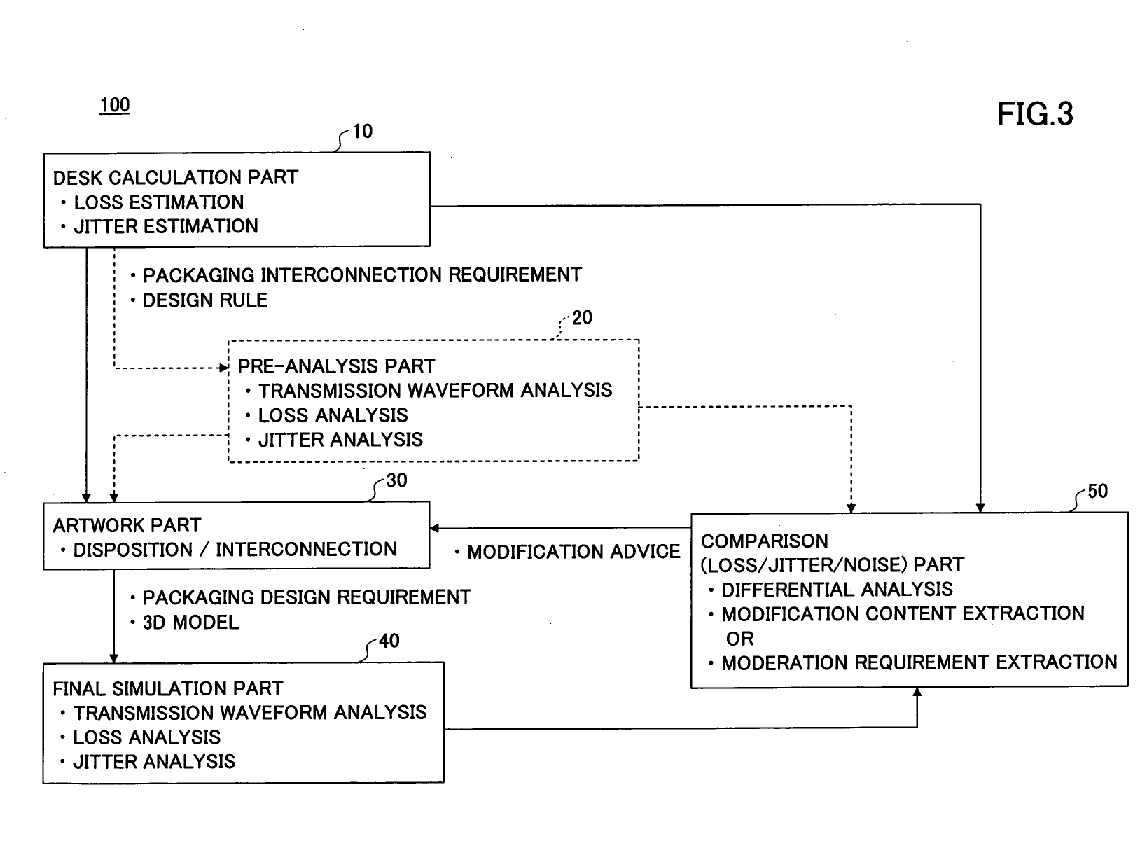

FIG. 3 shows a block diagram of a configuration of a circuit unit designing system 100 in the embodiment of the present invention.

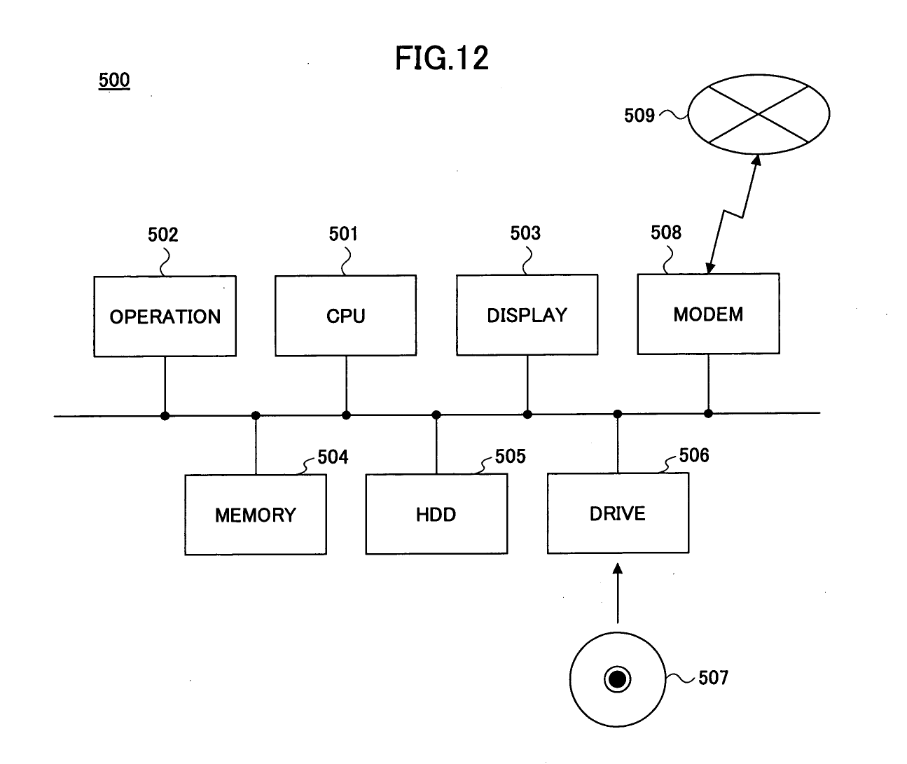

As shown in FIG. 3, the circuit unit designing system 100 includes a desk calculation part 10, an artwork CAD part 30, a final simulation part 40 and a comparison part 50. Further, as is necessary, a pre-analysis part 20 is further included. These parts can be achieved as a result of a computer configured as shown in FIG. 12 being operated according to a predetermined software program, i.e., a circuit unit designing program, for example.

The desk calculation part 10 estimates, by calculation, a loss or a jitter value, based on a catalog value, a standard value or such, of a circuit device component or a material to be applied in the circuit unit, for each element for each item, included in the circuit unit, based on a study result calculated for a packaging structure, before actual artwork, according to operation input and data input made by a designer who carries out the study for the packaging structure of the circuit unit. Then, according to the thus-obtained estimation calculating results, i.e., budgets, packaging interconnection requirements, design rules and so forth, for actual artwork of the circuit unit, are determined.

The pre-analysis part 20 carries out, before the actual artwork, an operation analysis of the circuit unit by means of computer's arithmetic operations, based on the study results obtained from the desk calculation part 10. Then, by means of carrying out a transmission simulation, a transmission waveform analysis, a loss analysis and a jitter analysis are carried out. For the simulation, a 3-D solver such as Poynting mentioned above, a circuit simulator such as HSPICE mentioned above, or such, may be applied.

The artwork CAD part 30 responds to operation input and data input of an artwork designer, and aids the artwork designer for packaging design of the circuit unit, i.e., artwork of the same, based on the study result for the packaging structure for the circuit unit provided by the desk calculation part 10.

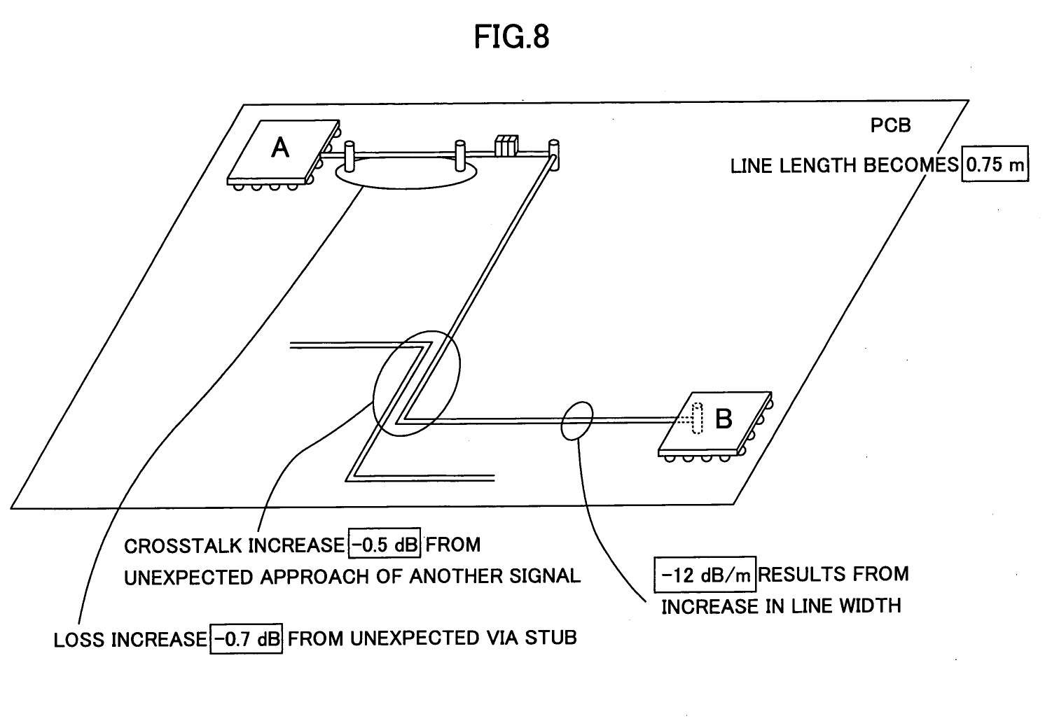

Specifically, with a common CAD function, artwork design contents, achieved from the operation input and data input by the artwork designer, are displayed in a 3-D manner on the CAD screen (see FIG. 8).

From the artwork CAD part 30, a 3-D model (see FIG. 8) and respective information such as actual design requirements concerning the artwork of the circuit unit, obtained from the artwork operations, which has been thus achieved by the artwork designer with the aid of the common CAD function of the artwork CAD part 30, is output.

The final simulation part 40 carries out an operation analysis of the circuit unit by means of computer's arithmetic operations based on these information, and carries out transmission waveform analyses, loss analyses and jitter analysis by means of a transmission simulation. Also for this simulation, the 3-D solver such as Poynting mentioned above, the circuit simulator such as HSPICE mentioned above may be applied.

The comparison part 50 compares circuit characteristics and so forth, which are analysis results obtained from the final simulation part 40 after the artwork, with the packaging structure study results obtained from the desk calculation part 10, and obtains differences therebetween.

There, for the circuit characteristics such as loss, jitter, noise and so forth, for each item for each element concerning the circuit unit, evaluation is made as to whether the analysis results obtained from the final simulation are worse or superfluous in performance with respect to the previous calculation values obtained from the desk calculation part 10.

When the final simulation analysis results are worse than the previous calculation results of the desk calculation part 10 as a result of the comparison, advice information is generated for a necessary design change to overcome the issue.

On the other hand, when the performance becomes superfluous as a result of the comparison, advice information for moderating the design requirements such as the design rules is generated.

That is, when the final simulation results are worse than the previous calculation results, this means that proper signal transmission meeting the predetermined requirements may not be available. Thus, in order to avoid such a situation, a necessary design change should be made.

On the other hand, when the performance is superfluous, this means that the given design requirements are too severe, and thus, an advice is provided to the artwork designer that the design requirements may be moderated. As a result, the artwork designer can recognize it as a design margin, and this information may be appropriately utilized in the total artwork of the circuit unit.

That is, the desk calculation part 10 and the final simulation part 40 (further the pre-analysis part 20, if necessary) of the circuit unit design system 100 as well as the comparison part 50 hold the respective parameter values representing the loss, jitter, noise and variation. The comparison part 50 updates the values of these parameters of its own, each time of obtaining the analysis results from the desk calculation part 10 or the final simulation part 40 (further the pre-analysis part 20, if necessary). In addition to the numerical comparison results, a modification or an alternative plan, an interconnection requirement moderation plan or such, is generated. Then, the thus-generated advice information is sent to the artwork CAD part 30, the information is then displayed on the CAD screen of the artwork CAD part 30. The artwork designer is thus advised for an appropriate modification of the present artwork contents.

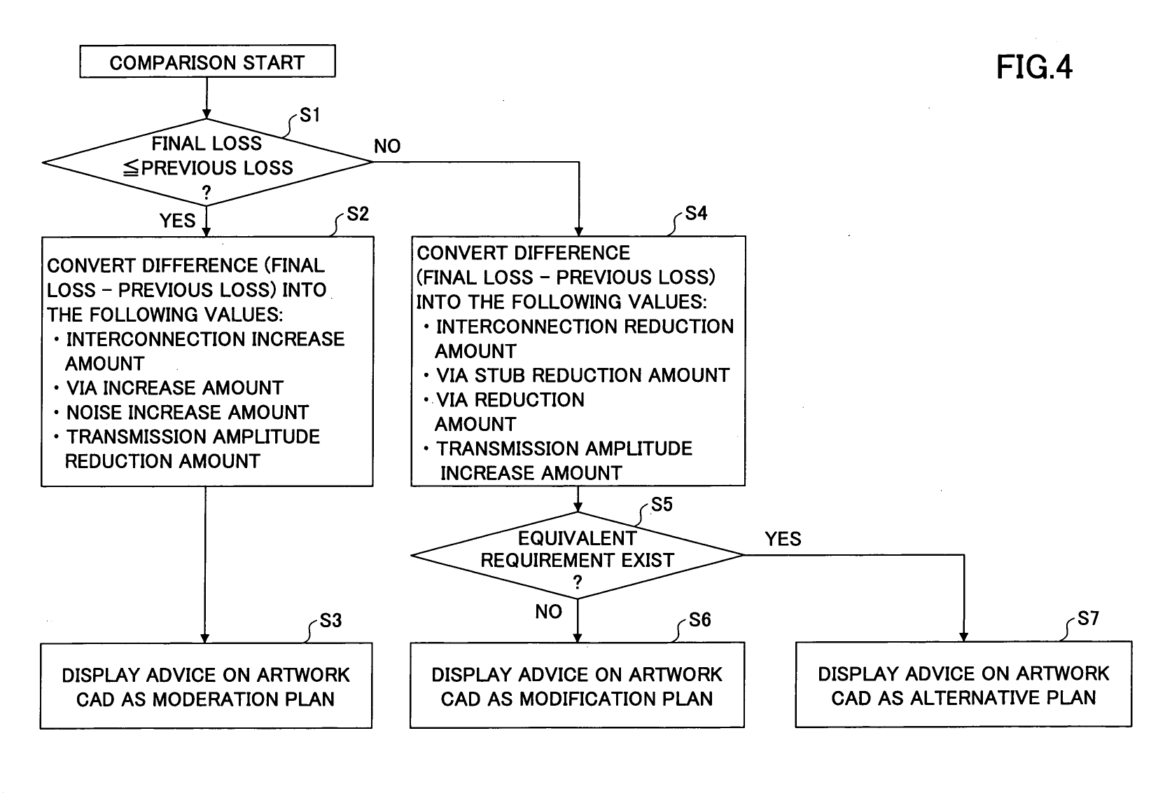

FIG. 4 shows a flow chart illustrating an operation flow of the circuit unit designing system 100 in the embodiment of the present invention described above.

In FIG. 4, the operation flow for processing concerning a loss comparison made by the comparison part 50 is shown. However, other than this, also for jitter or noise, processing can be made in the same manner.

In Step S1, the comparison part 50 compares the final loss, i.e., the signal transmission loss value of the circuit configuration obtained after the artwork by the final simulation part 40, with the previous loss, i.e., the signal transmission loss value of the circuit configuration based on the study result for the packaging structure before the artwork carried out by the desk calculation part 10, or the result of the operation characteristic analyses before the artwork carried out by the pre-analysis part 20.

When the final loss is equal to the previous loss, or the final loss is lower than the previous loss, this means that the current artwork contents provides superfluous performance, and thus, Step S2 is then carried out.

In Step S2, moderation requirements for moderating the design requirements in the current artwork contents are generated.

Specifically, the difference value between the final loss and the previous loss is converted into each of an allowable printed circuit substrate interconnection increasing amount, an allowable via increasing amount, an allowable noise increasing amount, an allowable transmission amplitude reduction amount and so forth.

Each of the allowable printed circuit substrate interconnection increasing amount, the allowable via increasing amount, the allowable noise increasing amount, the allowable transmission amplitude reduction amount and so forth, thus-obtained, corresponds to a value such that the final loss still falls within the previous loss range even when the design requirement is moderated within the thus-obtained amount.

Then, in Step S3, the thus-obtained moderation plans for the respective design requirements obtained in Step S2 are displayed on the CAD screen of the artwork CAD part 30 as advice information.

The artwork designer sees the advice information, and may appropriately utilize the same for the artwork operations carried out after that. That is, it is possible to adopt any one of these design requirement moderation plans, to moderate the corresponding design requirement.

On the other hand, when the final loss exceeds the previous loss in Step S1, this means that, according to the present artwork contents, the circuit unit may become such that the signal transmission loss value is too large to carry out proper signal transmission according to the predetermined requirements. Then, Step S4 is carried out.

In Step S4, modification requirements for making the present design requirements in the artwork severer are generated.

Specifically, the difference value between the final loss and the previous loss is converted into each of a necessary printed circuit substrate interconnection shortening amount, a necessary via reduction amount, a necessary noise reduction amount, a necessary transmission amplitude increasing amount and so forth.

Each of the necessary printed circuit substrate interconnection shortening amount, the necessary via reduction amount, the necessary noise reduction amount, the necessary transmission amplitude increasing amount and so forth, thus-obtained, corresponds to a value such that the final loss can be made to fall within the previous loss range when the design requirement is thus made severer by the thus-obtained amount.

Then, in Step S5, it is determined whether or not a requirement equivalent to the thus-obtained amount of making the design requirement severer obtained in Step S4 can be met by means of a design change of another element or another item of the circuit unit. Specifically, for example, it is determined in Step 5 whether or not, instead of shortening the interconnection on the printed circuit substrate or upgrading the material of the interconnection to reduce the loss of the transmission path, this issue can be solved by increasing the transmission performance of the transmitter, the reception performance of the receiver, or such, indirectly.

When it is thus determined in Step S5 that the issue can be thus overcome by the other element or the other item, that is, an alternative is available (Yes in Step S5), the specific contents thereof, i.e., the necessary increasing amount of the transmission performance of the transmitter or the reception performance of the receiver in the above-mentioned example, is submitted to the artwork designer, as a result of the same being displayed on the CAD screen of the artwork CAD 30 as advice information (Step S7).

On ht other hand, when no alternative is available (No in Step S5), the plans to make the respective design requirements severer obtained in Step S4 are submitted to the artwork designer, as a result of the same being displayed on the CAD screen of the artwork CAD 30 as the advice information (Step S6).

The artwork designer sees the advice information, studies how to change the artwork contents so as to make the loss fall within the previous loss, and then, actually carries out artwork operations according to the thus-obtained study result.

It is noted that, the comparison operations made by the comparison part 50 in Step S1 may be carried out during the artwork operations made by the artwork designer with the aid of the artwork CAD part 30. That is, during the artwork operations, the artwork designer inputs such instructions to the final simulation part 40 to cause it to execute the final simulation based on the artwork design contents in the present stage. Then, the artwork designer inputs such instructions to the comparison part 50 to cause it to execute comparison operations (Step S1) based on the result of the thus-obtained final simulation.

As a result, the artwork designer can obtain the final loss value even during the artwork operations, and therefore, when the final loss already exceeds the previous loss (No in Step S1) at the present interim stage, the artwork designer can recognize this issue earlier. As a result, in comparison to a case where the artwork designer recognizes the corresponding issue only at the stage of the completion of the whole artwork operations, it is possible to effectively reduce a possible loss in design time period required to overcome the issue.

Further, the artwork designer may try each of such respective design changes as those having mutually different contents, which serve as candidates, one by one, provisionally according to corresponding advices in response to the corresponding advice information displayed in Step S3, S6 or S7 obtained from the comparison of Step S1. Then, for each case, the final simulation part 40 calculates final simulation results, and the comparison part 50 carries out comparison operations. As a result, the artwork designer can compare and study as to which of the respective design changes in the above-mentioned candidates is most effective, and thus, can select the most effective design change.

These advantages can be obtained from the embodiment of the present invention as a result of the above-described operations of FIGS. 3 and 4 being automatically carried out by a computer, and also, all of the operation results being shown to the artwork designer.

That is, the work efficiency of the artwork operations carried out by the artwork designer would have considerably degrade if a long duration of interruption of the design work or a much amount of returning to a previous design process occurred. In the embodiment of the present invention described above, the artwork designer can obtain, only with simple operations to the computer, results of characteristic evaluations of the present artwork contents, or results of characteristic evaluations obtained from a design change, within a short time. Further, the artwork designer can obtain a specific advice, based on the evaluations, for design modification contents, design moderation contents, or design alternative contents.

Even when carrying out a design change, it is possible to effectively avoid a long duration of interruption of the design work or a much amount of returning to a pervious process, in the artwork operations.

That is, in the circuit unit designing system in the embodiment of the present invention, a correlation is obtained between the desk study results or the pre-analysis results, which are obtained relatively in an upstream stage of the design operations, and the final simulation results obtained after the artwork, and, a necessary modification or such for overcoming the issue of the difference from the initial estimation is advised. As a result, the artwork designer can effectively recognize the necessary artwork modification contents or such, and thus, can complete the artwork operations in an effectively reduced time period.

Further, since the artwork design properly according to the initial estimation can be achieved in an effectively reduced time period, it is possible to avoid an occurrence of returning to a previous process, as much as possible, and thus, it is possible to effectively reduce the required circuit unit developing man-hours.

Further, since also moderation of the artwork design requirements such as increasing an interconnection length or such is allowed for superfluous design with respect to the initial estimation. Thus, it is possible to improve the degree of freedom in the artwork.

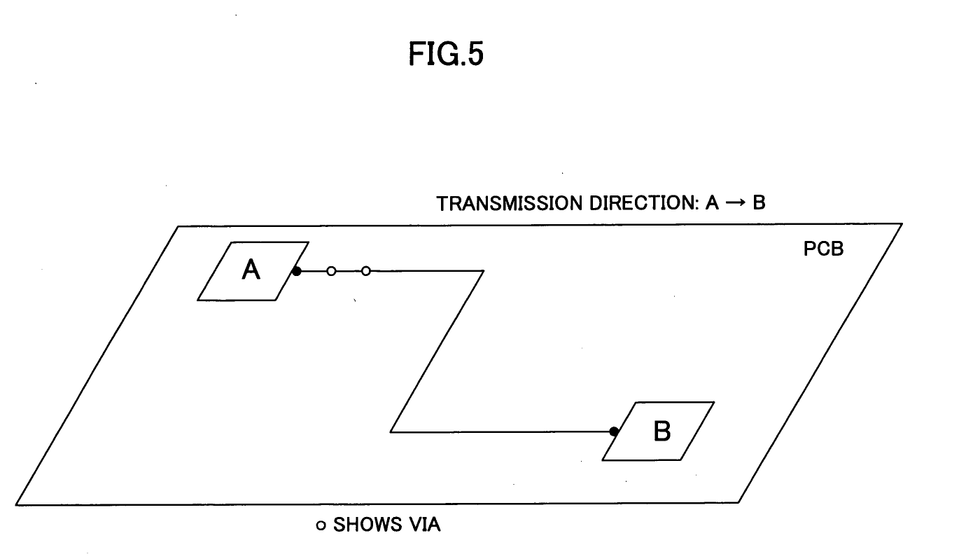

Next, with reference to FIGS. 5 through 11, actual application of the circuit unit designing system 100 in the embodiment of the present invention will be described.

FIG. 5 shows a packaging structure of a circuit unit.

As shown in FIG. 5, the circuit unit is such that, a transmitter A and a receiver B are disposed on a printed circuit substrate PCB, and are mutually connected by a transmission path. As shown, the transmission path has two vias.

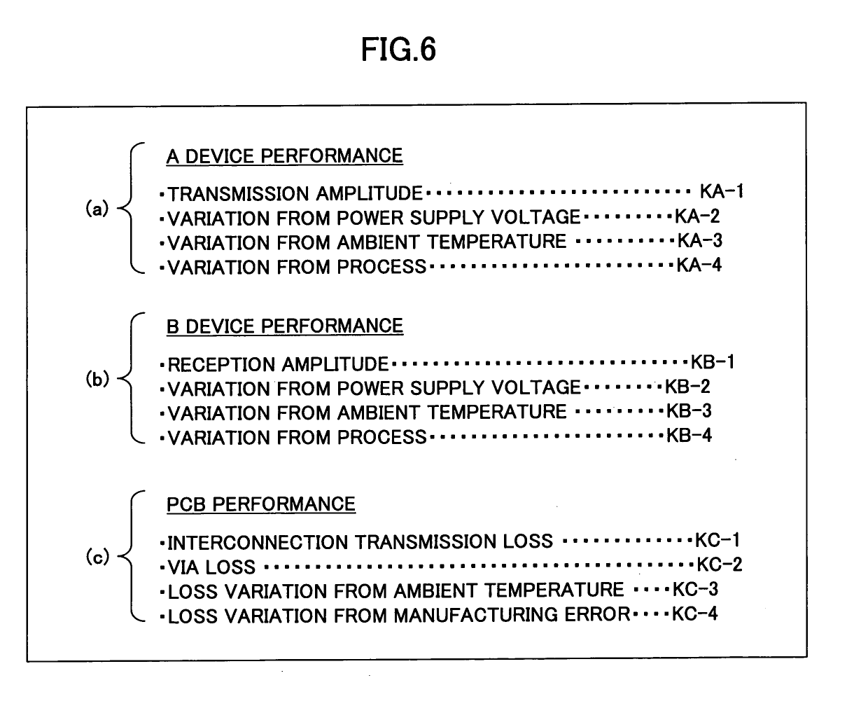

FIG. 6 shows respective elements included in the circuit unit having the packaging structure, that is, shows respective items to check for the transmitter A, the receiver B and the transmission path.

As the check items for the transmitter A and the receiver B, transmission/reception amplitude KA-1, KB-1; variation from power supply KA-2, KB-2; variation from ambient temperature KA-3, KB-3; and variation from process KA-4, KB-4, are set.

Further, for the transmission path including interconnections provided on the printed circuit substrate PCB, as the check items, interconnection transmission loss KC-1; via transmission loss KC-2; loss variation from ambient temperature KC-3; and loss variation from manufacturing error, are set.

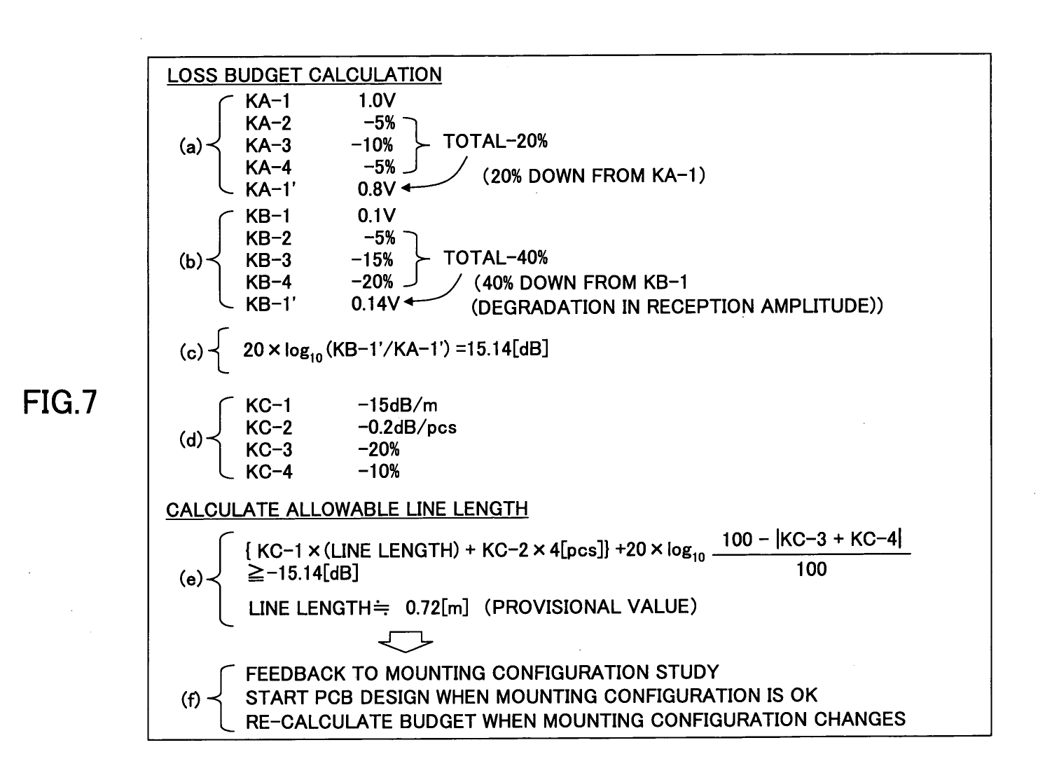

FIG. 7 shows an example of a loss budget calculation executed by the desk calculation part 10.

As shown in FIG. 7 (a), for the above-mentioned transmission amplitude, i.e., 1.0 V, decrease in 20% is anticipated in consideration of respective variations from power supply, ambient temperature and process, and consequently, it is calculated that it will result in 0.8 V (KA-1′).

Similarly, as shown in FIG. 7 (b), for the above-mentioned reception amplitude, i.e., 0.1 V, decrease in 40% is anticipated in consideration of respective variations from power supply, ambient temperature and process, and consequently, it is calculated that it should be raised to 0.14 V (KB-1′) for providing the corresponding allowance.

Then, in this case, as shown in FIG. 7 (c), it is calculated that an allowable loss between the transmission and reception amplitudes is −15.14 dB.

Next, in order to apply it to an actual transmission path, data of the transmission path shown in FIG. 7 (d) is substituted in a formula of FIG. 7 (e). Therefrom, it is found out that, a value obtained from a transmission loss per unit length of interconnection being multiplied by an actual line length, and then, a transmission loss by vias being added thereto, falls within the above-mentioned allowable loss of −15.14 dB. Then, by means of back-calculation therefrom, it is found out that, an allowable length of the transmission path, i.e., the interconnection length on the printed circuit substrate PCB is 0.72 [m] (i.e., a provisional value or an initial estimation value, see FIG. 7 (e)).

This result is fed back to a stage of studying the packaging structure before the artwork. When it has been confirmed that the above-mentioned allowable length of the interconnection length is achievable in the present packaging structure, subsequent artwork operations are started. However, when, in this stage, it is found out that the allowable length of the interconnection length is exceeded, the packaging structure is appropriately changed, and then, based on the contents including thus-made design change, the operations described above with reference to FIG. 7 are carried out again. When it is finally determined that interconnection meeting the allowable length of the interconnection length obtained in FIG. 7 (e) is achievable, the subsequent actual artwork is started.

FIG. 8 shows an example of a 3-D model of the circuit unit in a stage where the artwork with the use of the artwork CAD part 30 has been completed, or during the artwork. It is noted that, in the case of during the artwork, the values in the above-mentioned study stage are applied to a part for which the artwork has not been completed.

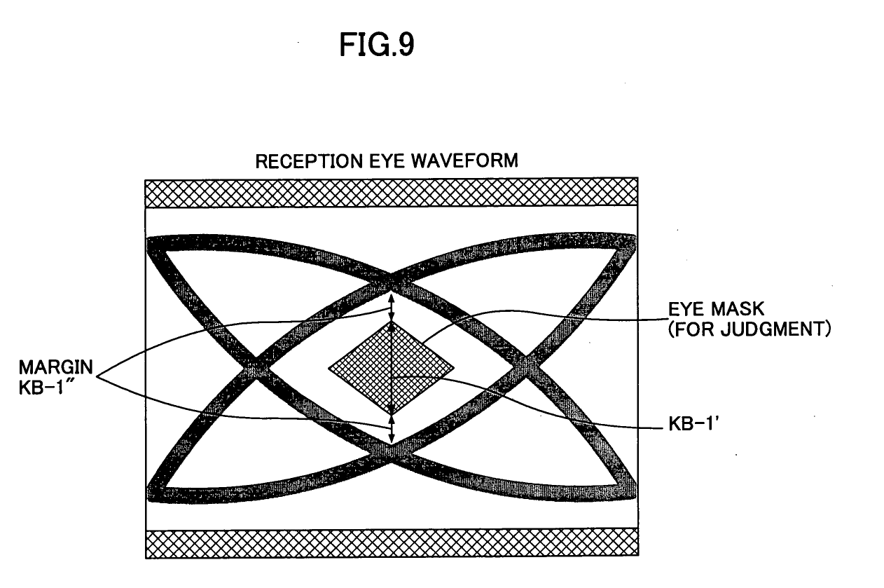

FIG. 9 shows an eye pattern of a reception waveform obtained from a transmission simulation for a 3-D model combining the transmitter A, the receiver B (in this example, each being of an LSI circuit device) and the transmission path on the printed circuit substrate PCB, based on the design contents obtained from the artwork.

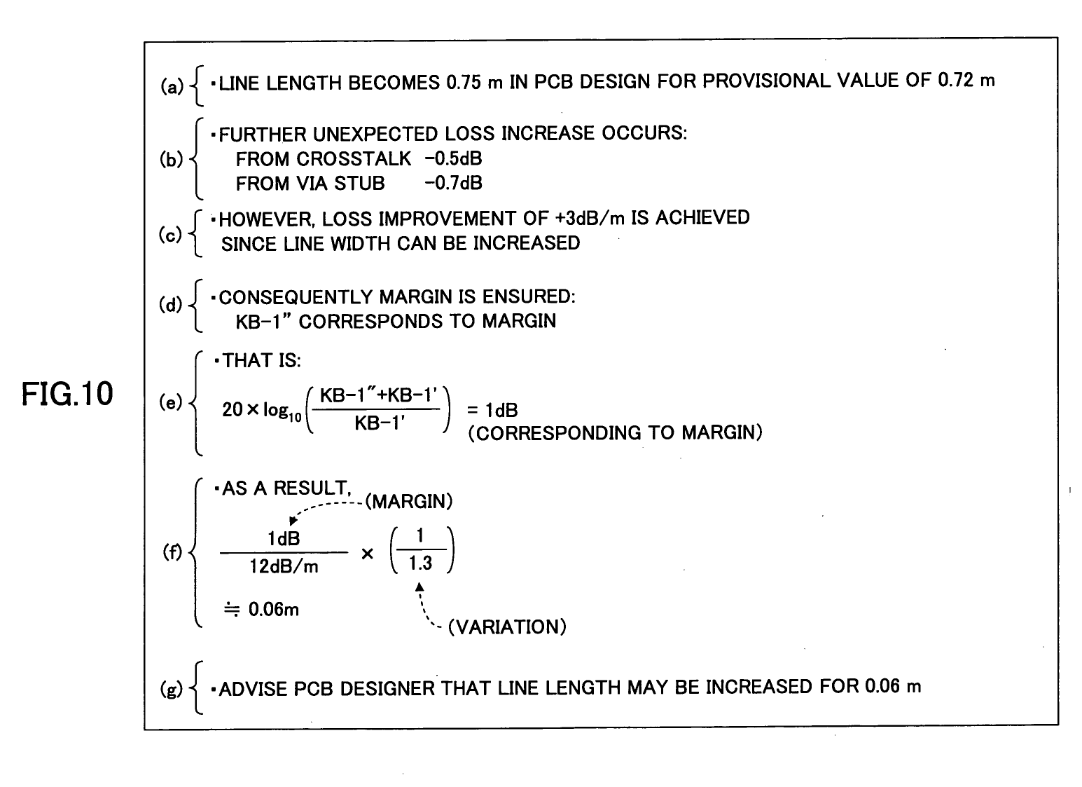

FIG. 10 shows a flow of comparison operations carried out by the comparison part 50, between this final simulation results and the above-mentioned study results obtained from the desk calculation part 10.

As shown in FIG. 10 (a), a transmission path line length comparison is carried out. That is, the line length of 0.75 m results from the artwork, while, as mentioned above, the provisional value or the initial estimation value is 0.72 m. Accordingly, it is found out that the actual values obtained from the artwork exceeds the provisional value or the initial estimation value.

Further, as shown in FIG. 10 (b), a transmission loss of −0.5 dB due to crosstalk and a transmission loss 0.7 dB due to via stub are found out as elements, not included in the initial estimation of FIG. 7.

On the other hand, as shown in FIG. 10 (c), it is found out that, the transmission path line width being can be increased in the artwork, the transmission loss per unit length can be reduced as a result, and consequently, from eye pattern of FIG. 9, loss improvement of +3 dB/m is achieved.

As a result, as shown in FIG. 10 (d), consequently a margin is obtained for the transmission path line length. That is, in this case, superfluous performance results.

Specifically, as shown in FIG. 10 (e), a loss margin of 1 dB is calculated. This means that the final loss is lower than the previous loss by 1 dB (Yes in Step S1 of FIG. 4). Thus, as shown in FIG. 10 (f), in consideration of a predetermined variation factor of 1.3, a margin of 0.06 m in the transmission path length results.

As a result, as advice information to the artwork designer, on the CAD screen of the artwork CAD part 30, as a design requirement moderation plan (in Steps S2 and S3 of FIG. 4). That is, a display is made to show that the transmission path line length can be increased (FIG. 10 (g)).

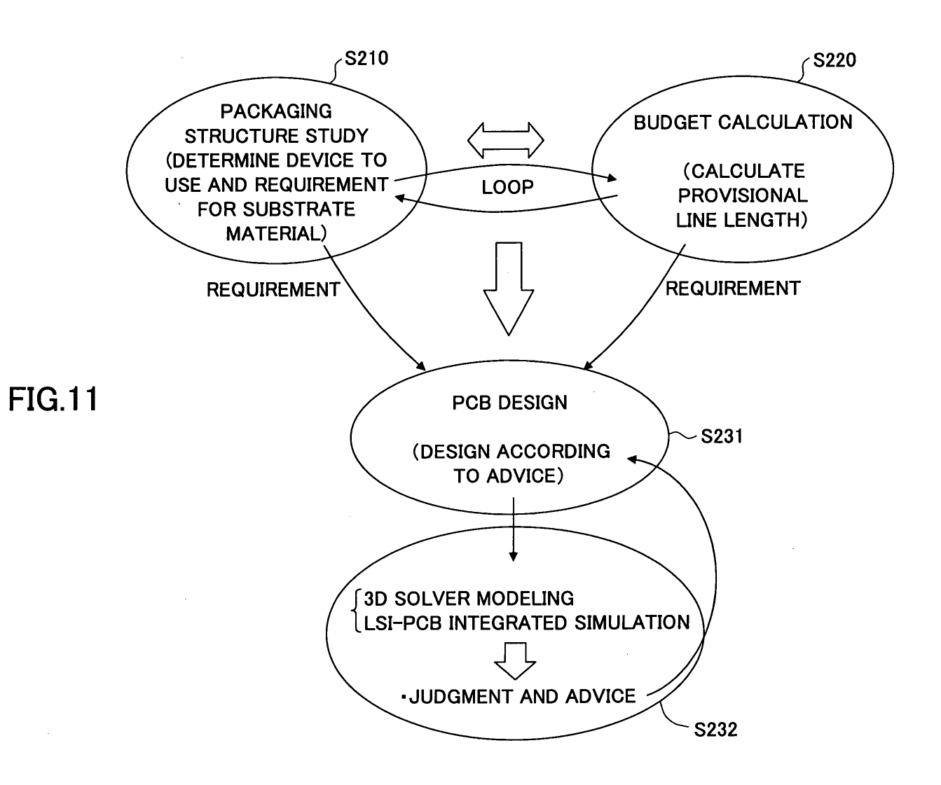

Thus, in the circuit unit designing system 100 in the embodiment of the present invention, as shown in FIG. 11, a study is made for a packaging structure, circuit device components to apply, substrate materials and so forth in a stage of studying the packaging structure of a circuit unit (Step S210, as shown in FIG. 5), a loss budget calculation is made based thereon (Step S220, as shown in FIGS. 6 and 7), and thus, the provisional transmission path line length is obtained (as shown in FIG. 7 (e)).

When the thus-obtained allowable line length is not met by the design requirements obtained from the study stage for the packing structure, the study stage for the packing structure (Step S210) is carried out again, and thus, the study for the packaging structure, the circuit device components, the substrate materials and so forth, is carried out again. The loop of Steps S210 and S220 is repeated until finally the allowable line length is met, that is, until the results of the study in Step S210 and the results of the loss budget calculation in Step S220 are consistent with one another.

Based on the thus-finally-obtained packaging structure study results, the subsequent artwork operations in a PCB designing stage (Step S231) are carried out.

After the completion or during the artwork operations, the final simulation operations in a modeling and simulation stage (Step S232) are carried out (as shown in FIGS. 8 and 9), and the simulation results thus-obtained are evaluated with reference to the budget calculation results of Step S220 (as shown in FIG. 10). Then, based on the thus-obtained evaluation results, an advice for a design change or such, is submitted to the artwork designer (as shown in FIG. 10 (g)).

The packaging structure study stage (Step S210) and the loss budget calculation stage (Step S220) of FIG. 11 are carried out by the functions of the desk calculation part 10, the PCB designing stage (Step S231) is carried out with the functions of the artwork CAD part 30, and the modeling and simulation stage (Step 232) is carried out by the functions of the final simulation part 40 and the comparison part 50.

FIG. 12 shows a block diagram of a computer for illustrating a case where the above-described circuit unit designing system 100 in the embodiment of the present invention is realized by the computer.

As shown in FIG. 12, the computer 500 includes a CPU 501 for carrying out various operations by executing instructions written in a given program; an input part 502 such as a keyboard, a mouse, and so forth, for a user to input operation contents or data; a display part 503 such as a CRT, a liquid crystal display device or such, for displaying, to the user, a processing progress, a processing result or such of the CPU 501; a memory 504 such as a ROM, a RAM and so forth, for storing the program to be executed by the CPU 501, or to be used as a work area of the CPU 501; a hard disk drive 505 for storing the program, data and so forth; a CD-ROM drive 506 for loading the program or data from the outside with the use of a CD-ROM 507 as an information recording medium; and a modem 508 for downloading the program or such, from an external server via a communication network 509 such as the Intent, LAN or such.

The computer 500 loads or downloads the program, i.e., the circuit unit designing program, having the instructions for causing the CPU 501 to execute the above-described processing of the circuit unit designing system 100, and carries out the corresponding functions, appropriately, according to the instructions written in the program. The CD-ROM 507 may be used as an information recording medium, or the communication network 509 may be used, for loading or downloading the circuit unit designing program. The circuit unit designing program is then installed in the hard disk drive 505, is loaded on the memory 504, and is executed by the CPU 501. As a result, the computer 500 acts as the circuit unit designing system 100.

The present invention is not limited to the above-described embodiment, and variations and modifications may be made without departing from the basic concept of the present invention claimed below.

The present application is based on Japanese Priority Application No. 2006-263125, filed on Sep. 27, 2006, the entire contents of which are hereby incorporated herein by reference.

What is claimed is:

1. A circuit unit designing apparatus configured to design a circuit unit in which, on a substrate, a plurality of circuit components are disposed, comprising:
a circuit designing part carrying out circuit design;
an initial characteristic calculating part calculating characteristics of the circuit unit from characteristics of the substrate and the respective circuit components, before the circuit design;
an after design characteristic calculating part calculating characteristics of the circuit unit based on the circuit design result;
a characteristic comparing part comparing the characteristics of the circuit unit obtained by said initial characteristic calculating part and those obtained by the after design characteristic calculating part, from one another; and
an advice generating part generating an advice for a designer for a necessary design change based on the comparison result.

2. The circuit unit designing apparatus as claimed in claim 1, wherein:
the characteristics of the circuit unit comprise those concerning at least any one of loss, noise and jitter.

3. The circuit unit designing apparatus as claimed in claim 1, wherein:
the necessary design change comprises a modification of a circuit element itself which corresponds to a cause of the necessary design change.

4. The circuit unit designing apparatus as claimed in claim 1, wherein:
the necessary design change comprises a modification of a circuit element other than a circuit element which corresponds to a cause of the necessary design change.

5. A circuit unit designing method for designing a circuit unit in which, on a substrate, a plurality of circuit components are disposed, comprising:
a circuit designing step of carrying out circuit design;
an initial characteristic calculating step of calculating characteristics of the circuit unit from characteristics of the substrate and the respective circuit components, before the circuit design;
an after design characteristic calculating step of calculating characteristics of the circuit unit based on the circuit design result;
a characteristic comparing step of comparing the characteristics of the circuit unit obtained by said initial characteristic calculating part and those obtained by the after design characteristic calculating part, from one another; and
an advice generating step of generating an advice for a designer for a necessary design change based on the comparison result.

6. The circuit unit designing method as claimed in claim 5, wherein:
the characteristics of the circuit unit comprise those concerning at least any one of loss, noise and jitter.

7. The circuit unit designing method as claimed in claim 5, wherein:
the necessary design change comprises a modification of a circuit element itself which corresponds to a cause of the necessary design change.

8. The circuit unit designing method as claimed in claim 5, wherein:
the necessary design change comprises modification of a circuit element other than a circuit element which corresponds to a cause of the necessary design change.

9. A circuit unit designing program comprising instructions to cause a computer to carry out design of a circuit unit in which, on a substrate, a plurality of circuit components are disposed, said instructions causing the computer to carry out:
a circuit designing step of carrying out circuit design;
an initial characteristic calculating step of calculating characteristics of the circuit unit from characteristics of the substrate and the respective circuit components, before the circuit design;
an after design characteristic calculating step of calculating characteristics of the circuit unit based on the circuit design result;
a characteristic comparing step of comparing the characteristics of the circuit unit obtained by said initial characteristic calculating part and those obtained by the after design characteristic calculating part, from one another; and
an advice generating step of generating an advice for a designer for a necessary design change based on the comparison result.

10. The circuit unit designing program as claimed in claim 9, wherein:
the characteristics of the circuit unit comprise those concerning at least any one of loss, noise and jitter.

11. The circuit unit designing program as claimed in claim 9, wherein:
the necessary design change comprises modification of a circuit element itself which corresponds to a cause of the necessary design change.

12. The circuit unit designing program as claimed in claim 9, wherein:
the necessary design change comprises modification of a circuit element other than a circuit element which corresponds to a cause of the necessary design change.
